(19) United States
(12) Patent Application Publication
(10) Pub. No.: US 2008/0225021 A1
(43) Pub. Date: Sep. 18, 2008

(54) Multi-Primary Driving Values Calculation Unit and Method

(75) Inventors: Gerben Johan Hekstra, Eindhoven (NL); Brechje Hendrica Okker, Singapore (SG)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/575,075

(22) PCT Filed: Sep. 8, 2005
(86) PCT No.: PCT/IB2005/052935

§ 371 Date: Jan. 14, 2008

(30) Foreign Application Priority Data
Sep. 15, 2004 (EP) 04104462.9

(51) Int. Cl. G06F 3/038

(52) U.S. Cl. 345/204

(57) ABSTRACT

The calculation unit (220) is arranged for calculating based on an input target color (T,TV) as output a number (n), larger than three, of quantized driving values ([R′]o, [G′]o, [B′]o, [C′]o) usable for driving an electronic multi-primary display unit (200) with the same number (n) of primaries to substantially reproduce the target color (T,TV), and comprises a determination unit (224), arranged to determine based upon the target color (T,TV) quantized initial values ([R′], [G′], [B′], [C′]) for each of the driving values, and an optimization unit (232) arranged to determine the driving values ([R′]o, [G′]o, [B′]o, [C′]o) selected from a set (CS) of candidate tuples of driving values, determined based on the initial values ([R′], [G′], [B′], [C′]), as a candidate which leads to reproduction (RP) of a color which is closest over all candidates in the set (CS) to the target color (T,TV) according to a predetermined error criterion (E(R,T)). With this calculation unit more accurate color reproduction can be achieved.

The invention relates to a calculation unit arranged for calculating based on an input target color as output a number, larger than three, of quantized driving values usable for driving an electronic multi-primary display unit with the same number of primaries to substantially reproduce the target color.

The invention also relates to a multi-primary display device comprising such a calculation unit.

The invention also relates to method of calculating based on an input target color as output a number, larger than three, of quantized driving values usable for driving an electronic multi-primary display unit with the same number of primaries to substantially reproduce the target color.

The invention also relates to a software implementing this method.

Ever since its emergence in the fifties, color television has functioned with three reproduction (additive) primary colors (often called primaries in short). The same can be said for celluloid movies: after a period of manual multicolor coloring and some two primary movies, current movies employ three primary colors. The rationale behind this choice is that a standard human observer has three types of cone in his retina. Hence if a spot on the retina is illuminated with a particular combination of three primary colors (with particular spectra), this gives a color sensation which cannot be discriminated by the observer from a multitude of other illumination spectra. This principle is called metamerism. The objective of designing a color display is to choose three primaries, so that the naturally occurring object spectra (e.g. of a lemon) can be emulated by using metamerism.

One may reflect on whether the three primary reproduction is satisfactorily accurate, e.g. for a color-anomalous viewer. However from a practical point of view current color television is considered to reproduce colors satisfactorily. In any case, the actually perceived color of objects on the display is a function of a vast number of factors, such as e.g. environmental light.

On the production side the camera and color manipulation are also not calorimetrically exact, but rather attuned practically, so that at least face colors are acceptable.

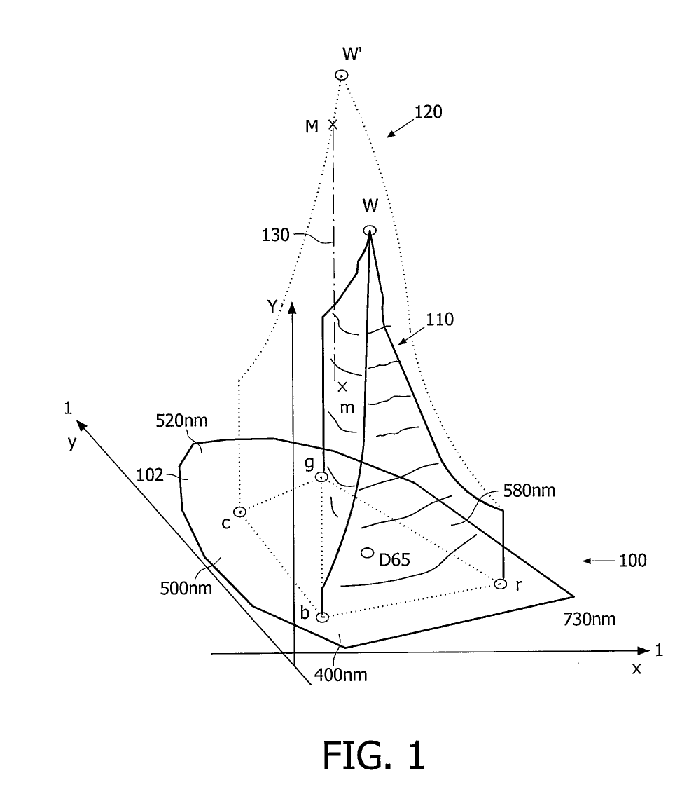

The last years however, there has been a drive in a number of companies and research institutes towards so-called multi-primary color displays, with which term the skilled person describes displays which have more than three primaries, e.g. 4, 5, 6 or even 32 or more. When current three-primary displays were designed, one realized that one should choose a red, green and blue primary (see the triangle in FIG. 1) to be able to reproduce as many natural colors as possible (in technical terms the total volume in color space of reproducible colors is called the display gamut, not to be confused with the display gamma, or tone reproduction curve). The actual color points of the phosphors used in CRTs were chosen on the basis of such factors as luminous efficiency. One can prove mathematically however, that with an additive (multi-primary) display, only those colors that lie within a convex region of the color plane (e.g. the xy standard color plane) bounded by the lines connecting the primary colors can be reproduced. E.g. for a standard PAL CRT television only the colors within the triangle r,g,b of FIG. 1 can be reproduced. The spectral color locus curve 102 shows the loci in the color plane x,y of monochromatic (single wavelength) colors, hence all naturally possible colors fall within this curve 102, but a number of colors (e.g. the cyan color c) lie outside the PAL triangle r,g,b, and hence cannot be reproduced on a PAL CRT television. Other display technologies have their own version of a triangle dependent on the display physics, e.g. LCDs often have a non-optimal rather unsaturated blue primary. Actually, one can easily see that because of the shape of the spectral locus, no selection of three primaries can ever reproduce all natural colors. I.e., although large-triangle three-primary displays can display most naturally occurring colors, e.g. all the pastel colors inside the triangle, three primaries are not enough for natural color reproduction.

Although most colors that fall outside the triangle, e.g. lemon yellow, are only displayed slightly desaturated, which should usually if already noticed by the viewer not be objectionable, large color gamuts are still preferred. E.g. a viewer may prefer unnaturally highly saturated colors over the ones which can be reproduced by the PAL CRT television.

One of the factors braking the introduction of multi-primary displays has been the mathematics of obtaining the correct driving values for the display (e.g. the voltage that must be applied to the red electron gun of a CRT to attain the correct proportion of red required for reproducing the color). For a three-primary display, the driving values can easily be calculated, since they follow from a set of three equations (the three sensation dimensions of a viewer) with three unknowns (the three primary channels to reproduce uniquely any of those sensations), as can be seen in Eq. 1 below.

For a multi-primary display it is not clear how one should determine the driving values. In any case, there is not just one set of driving values that leads to the same color sensation, but a multitude. It is then not clear which set of driving values one should choose. It is clear that a choice should be made, i.e. some kind of additional constraint/equation is desired, but there are different ways of choosing this constraint, e.g. based on lifetime of the display when particular driving values are applied (e.g. if one channel is never used, it will age more slowly).

After considerable reflection, a number of generic methods were developed, which are all similar and are typically illustrated by WO 02/099557, in which the idea is to determine a specific set of driving values based on generating the color from contributions on the boundary of the gamut, where the number of degrees of freedom is small.

However, although the output of this process is a particular set of driving values which approximately reproduces the target color, a disadvantage of the method of WO 02/099557 is that the ensuing particular set of driving values is not necessarily the optimal one (according to a particular desideratum) and another of the multitude of possibilities may be better.

It is an object of the invention to provide a calculation unit which is capable of determining a more appropriate set of driving values for a target color, in particular a set of driving values leading to highly accurate color reproduction.

This object is realized in that the calculation unit comprises a determination unit, arranged to determine, based upon the target color, quantized initial values ([R′], [G′], [B′], [C′]) for each of the quantized driving values, and the calculation unit comprises an optimization unit arranged to:

generate a set (CS) of candidate tuples of quantized driving values based on the quantized initial values ([R′], [G′], [B′], [C′]); and

select the quantized driving values ([R′]o, [G′]o, [B′]o, [C′]o) to drive the display from the set (CS) as a candidate which leads to reproduction (RP) of a color which is closest over all candidates in the set (CS) to the target color (T,TV) according to a predetermined error criterion.

N.B. A tuple is an array of numbers, somewhat like a vector.

A skilled person desiring increased accuracy might want to arrive at a more accurate set of driving values by recalculating them with another multiprimary color-to-driving values strategy. However going through all possible combinations would require an enormous amount of calculations, which is not realizable for real-time video systems.

By checking the reproduction accuracy in the optimization unit no complex mathematical color-to-driving value calculations are required, but only a straightforward forward driving value-to-color model is needed. The calculation unit according to the invention can be easily tuned according to the amount of calculations available. If only few calculations are possible, the candidate set is kept small, but the downside is that the accuracy is possibly not increased very much. Experiments have shown that with a reasonable small candidate set, already good results can be achieved. Different heuristics may be designed for determining a good path for quickly arriving at a good set of driving values starting from the initial values.

In an embodiment of the calculation unit which the optimization unit comprises a candidate generation unit arranged to determine the set of candidate tuples of driving values as the ensemble of tuples of those driving values which lie within a number of discrete levels N_{d}, for an associated dimension d, of multi-primary driving value space from the respective initial value ([R′], [G′], [B′], [C′]).

Constraining candidates to a fixed (typically small number of discrete values) region around the initial value usually leads to a significantly increased accuracy and the candidates can be simply generated by going through all offsets (i.e. adding them to the initial values). Furthermore in this way it is guaranteed that driving values will not fluctuate wildly. Furthermore, small offsets from the initial value makes the method/unit robust against the difference between the model and actual gamma behavior of a display.

In a further embodiment of the calculation unit, the candidate generation unit comprises an offsets memory, containing driving value offset tuples, which are predetermined based on experiments as having a high probability of generating a closer to target candidate when added to the initial values ([R′], [G′], [B′], [C′]), and a candidate generator arranged to add component-wise a tuple of offsets to the initial values ([R′], [G′], [B′], [C′]).

To reduce the amount of calculations further, use can be made of the fact that instead of going through all offsets, only particular offsets may be checked (e.g. the offset hypercube may be subsampled). Good candidates may be prestored and only there (or some of these) are then sent to the candidate generator, to have their reproduction accuracy checked. Different theories may lead to a subset.

In another further embodiment of the calculation unit the candidate generation unit comprises an offsets memory (306), containing driving value offset tuples, and an offset selector arranged to select according to a predetermined criterion a particular tuple of offsets in dependence on an error (e) being the evaluation result of the predetermined error criterion, and a candidate generator arranged to add component-wise the particular tuple of offsets to the initial values ([R′], [G′], [B′], [C′]).

To reduce the amount of candidates that have to be checked, the hypercube of offsets can also be traversed dynamically, i.e. the next candidate is dependent on the current candidate and the reproduction result achieved with it.

It is advantageous to further arrange the previous calculation unit embodiment by further arranging the offset selector to select the particular tuple of offsets in dependence on the target color.

E.g. near the gamut boundary some offsets may be more successful than others.

It is advantageous to embody the calculation unit with an optimization unit which comprises an error evaluation unit arranged to evaluate the predetermined error criterion having a different contribution to the resulting error (e) of luminance versus chromaticity errors. This can take account the different psychovisual importance of (particular) chromaticity vs. luminance errors.

The calculation unit is useful when comprised in a multi-primary display device which further comprises a multi-primary display unit connected to the calculation unit to receive the quantized driving values.

Analogously to the calculation unit a method is provided of calculating based on an input target color as output a number, larger than three, of quantized driving values ([R′]o, [G′]o, [B′]o, [C′]o) usable for driving an electronic multi-primary display unit with the same number of primaries to substantially reproduce the target color, the method comprising:

determining based upon the target color quantized initial values ([R′], [G′], [B′], [C′]) for each of the driving values;

generating a set of candidate tuples of quantized driving values based on the quantized initial values ([R′], [G′], [B′], [C′]) determining the quantized driving values ([R′]o, [G′]o, [B′]o, [C′]o) by selecting from the set a candidate which leads to reproduction of a color which is closest over all candidates in the set to the target color according to a predetermined error criterion. This method may be realized in different ways as software, enabling e.g. a personal computer receiving video from the Internet to drive a home cinema multiprimary projector.

These and other aspects of the calculation unit according to the invention will be apparent from and elucidated with reference to the implementations and embodiments described hereinafter, and with reference to the accompanying drawings, which serve merely as non-limiting specific illustrations exemplifying the more general concept, and in which dashes are used to indicate that a component is optional.

In the drawings:

FIG. 1 schematically shows the gamut of a 3-primary and multi-primary color display;

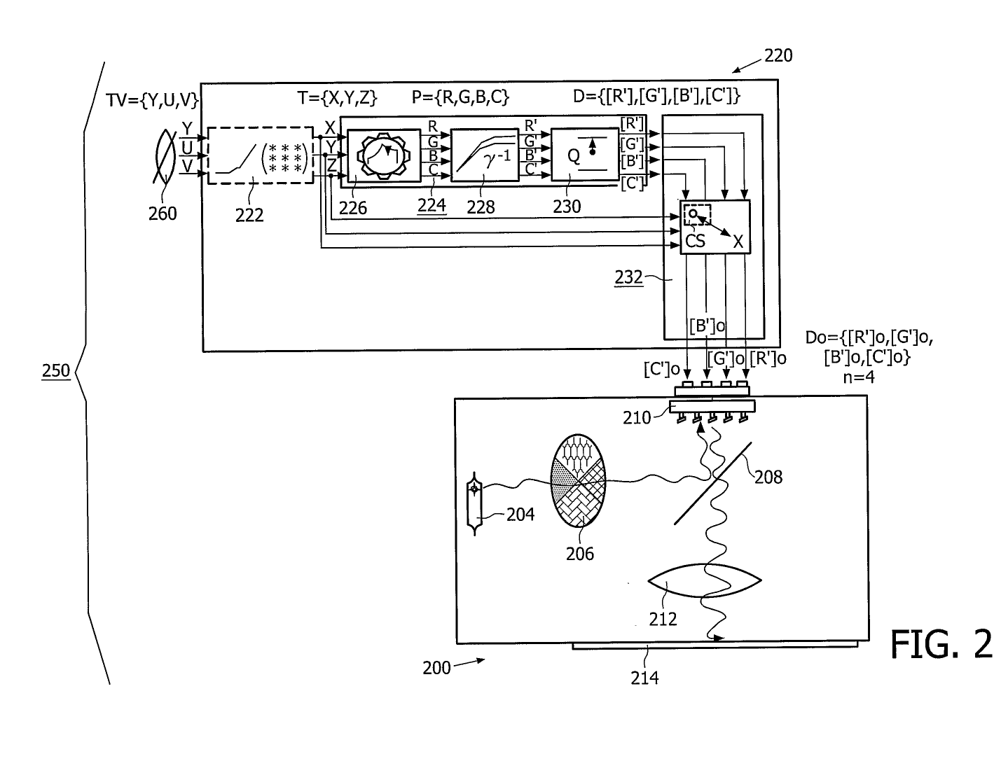

FIG. 2 schematically shows the calculation unit of the invention in a multi-primary display device;

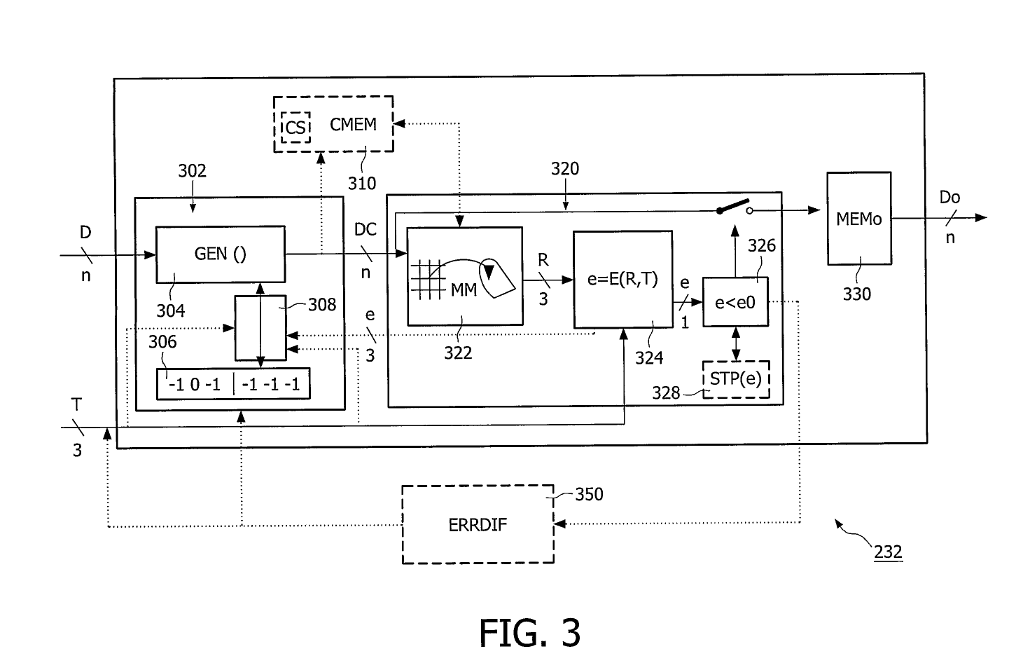

FIG. 3 schematically shows an exemplary embodiment of an optimization unit of the calculation unit;

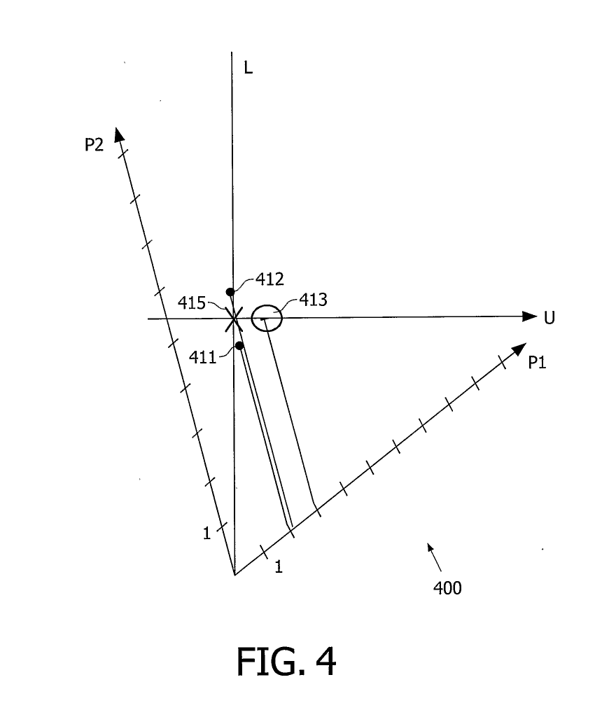

FIG. 4 symbolically shows multi-primary reconstruction for a monochromat observer; and

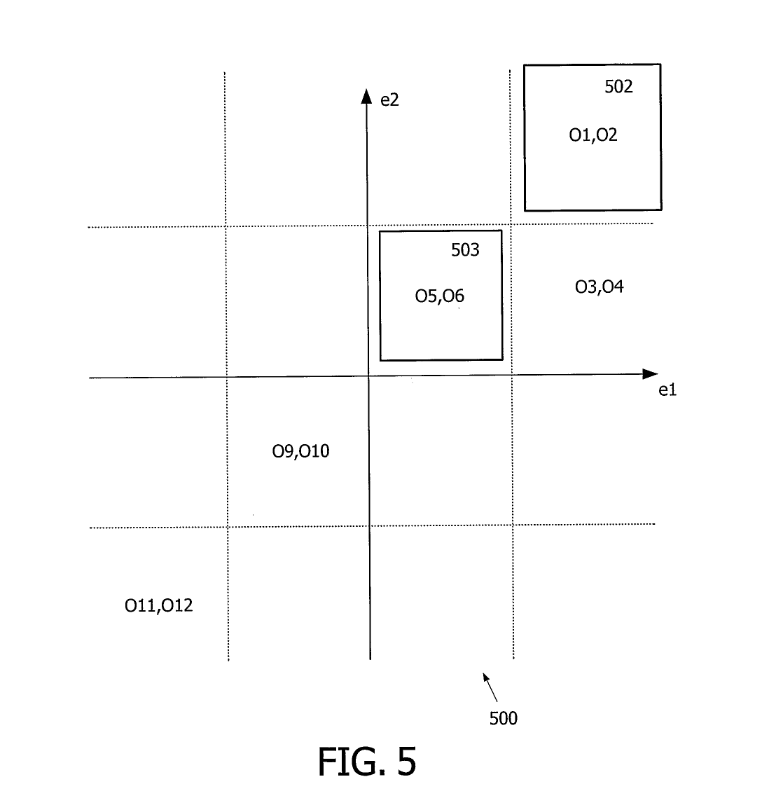

FIG. 5 schematically shows optimal offsets for different regions of error space.

FIG. 1 schematically shows gamuts—i.e. all colors which can be reproduced by a color reproduction device—of electronic additive displays in a color (x,y) and luminance (Y) space. The tent-shape 110 drawn with solid lines is the gamut for a three primary display, such as e.g. a currently popular CRT television with EBU (European Broadcasting Union) standard compatible phosphors, which were chosen according to a number of technical constraints such as e.g. efficiency. Also shown is the gamut of a four primary device 120 (dashed lines). It can be shown mathematically that the chromaticities (x,y) of reproducible colors on the display lie within the convex polygon constructed from the primary chromaticities (in this example small r,g,b and c), and that all three-dimensional reproducible colors (e.g. specified as a tuple (x,y,Y) or in linear additive (X,Y,Z)-space) lie within the tent-shaped gamut.

Also shown are the chromaticities of monochromatic spectra, the so-called spectral locus 102, popularly known in the color world as the horseshoe. All object spectra in nature have colors within this horseshoe-shaped locus. It can be seen that the three-primary display cannot reproduce all chromaticities, e.g. not the chromaticity c. In fact one can show mathematically that no three primary display can ever reproduce all colors within the horseshoe. The volume of the 4 primary (4P) gamut 120 is also much larger than that of the 3P gamut, not just because it has a larger support in the chromaticity plane (x,y), but also because for a particular color reproducible by the 3P display higher luminances can be achieved.

This may be partly because four primaries (e.g. in a LED-display) just emit more light, hence the white W′ (obtainable by sending a maximum driving value to all primary display channels) of the 4P display has a higher luminance than the white W of the 3P display. This will be less marked for e.g. an LCD multiprimary display, since its maximum luminance is dictated by the backlight.

A fair measure (disregarding the effect of the white luminance) of the extent of a display gamut is obtained by comparing it with the gamut of so-called ideal colors. It can be proven mathematically that these have a maximum luminance for a given chromaticity, and the are formed by filtering the white light with filters which have spectral amplitudes equal to zero or one, and 1 or 2 infinitely steep crossings between 0 and 1 parts.

It can then be seen that the multiprimary gamuts have broader regions around white, i.e. for a particular chromaticity they can reproduce a higher (normalized) luminance. In any case, multiprimary displays can reproduce more colors.

Current color television (as well as other reproduction strategies, such as e.g. photoprints) is from practical perspective judged satisfactory in its color reproduction. A large fraction of actually occurring colors in nature falls within its chromaticity triangle (r,g,b in FIG. 1), although colors on the boundary may not be reproducible with the required luminance, which typically lead to clipping errors.

However, the last decade more interest has emerged in making wider-gamut (i.e. multiprimary, which stands for more than three primaries, e.g. 4 or 6) displays, since e.g. a number of cyan paint colors, magenta cloth coloring dies and yellow object colors cannot be faithfully reproduced. This has led to a number of multiprimary displays based on different color reproduction technology. In fact the calculation unit of the present invention can be used for such displays as e.g.:

a projector with more than three color filters (e.g. in a color wheel) and one or more light modulators

a LED display with more than three different primary LEDs

an LCD with multiple color filters and or multiple backlights etc.

However an important difficulty along the path to practical multiprimary displays has not so much been the construction of the display hardware, but the software/mathematics for obtaining the required driving values for reproducing a target color.

The mathematics of an additive three primary display, as current television employs, is simply modelable:

$${( \begin{matrix}X \\ Y \\ Z\end{matrix} )}_{T} = ( \begin{matrix}{X}_{r} & {X}_{g} & {X}_{b} \\ {Y}_{r} & {Y}_{g} & {Y}_{b} \\ {Z}_{r} & {Z}_{g} & {Z}_{b}\end{matrix} ) ( \begin{matrix}{Γ}_{r} ( {R}^{′} ) \\ {Γ}_{g} ( {G}^{′} ) \\ {Γ}_{b} ( {B}^{′} )\end{matrix} ) + B = {ML}_{D} + B \qquad [ Eq . 1 ]$$

In equation 1 the target color T to be reproduced is represented as its X,Y and Z values, and obtained from a matrix multiplication of the matrix of primaries M (which contains the X,Y,Z contributions of unity primary driving: e.g. when giving a [255,0,0] driving tuple unity red is displayed) with the tuple of driving weights LD, which is related to the actual driving values R′, G′ and B′ via the gamma behavior (modeled with functions such as Γᵣ(R′)) of the display hardware. B is a black leakage color which can be included in Eq. 1 for improved precision.

From this theoretical equation, giving a target color the required driving values can easily obtained by matrix inversion, since there are three unknowns and three equations, since color vision is three-dimensional (at least according to the simple but satisfactorily accurate models employed in color reproduction technology).

For a multiprimary display however, there are more unknowns than equations, since e.g. 4 driving values (R′,G,′B′,C′) are required. Hence the mathematics is not simply invertible, i.e. there are infinitely many solutions.

This is shown simplifiedly for a monochromat observer, i.e. an observer who only sees grey values L, and two primaries P1 and P2 in FIG. 4. The target color 415 indicated with a cross can be reproduced by using a contribution of two units of P1, but the required added 4.5 units of P2 means that both 4 units, leading to reproduction point 411, and 5 units, leading to point 412 give rise to a considerable luminance L error. However, a reproduction 413 with tuple [3,4] does reproduce the target luminance L rather accurately, and the monochromat viewer cannot perceive the difference in color U between the reproductions anyway.

However choosing a solution arbitrarily can lead to all kinds of annoying effects, such as errors, differential aging of the channels etc.

Relatively few multiprimary driving calculation strategies exist, all of which are based on the same idea: reducing the number of degrees of freedom.

For the present invention we are interested in an algorithm that yields relatively smoothly varying driving values, i.e. if a color T requires driving values (A′,B′,C′, . . . ), then a neighboring color T+ε should require driving values which are little different, e.g. (A′+α, B′+β, C′+γ, . . . ), in which α, β and γ have values which are considerably smaller than the total range of driving values e.g. equal to a few (e.g. 0, 1, 2 or 3) discrete driving values, and hence not (15*A′,0,22*C′, . . . ).

A possible way of calculating multiprimary driving values according to WO 02/099557 (called in short the “Genoa method” in the present text) is shown schematically in FIG. 1.

Color m, which is clearly within the 4P gamut 120 has to be reproduced, and can be reproduced with different contributions of r, g, b and c. A color M on the border of the gamut with the same chromaticity but maximum luminance is calculated. Since the border of the gamut has few degrees of freedom (e.g. in linear color space a border facet is obtained by setting all primary driving values except for two of them to zero), there is a unique driving value combination to make color M. These values can be precalculated and stored in a memory for all chromaticities. Due to the linear nature of additive color reproduction, a color m of similar chromaticity but lower luminance follows simply be scaling the stored unique driving values by the ratio of the luminances of M and m.

Although this provides a way of calculating uniquely the required driving values for reproducing a color which is approximately equal to the required target color, the resulting reproduced color is by no means the best possible reproduction. In other words, the resulting driving values are not the optimal driving values. The problem occurs because the driving values are quantized. With an infinitesimally precise driving value, the proposed method would yield an exact color reproduction. However due to quantization, the driving values tuple [2,17, 8, 21] may lead e.g. to a color which is slightly too reddish (or to light) whereas countering the redness by increasing the cyan (anti-red) contribution to [2, 17, 8, 22] may lead to a color which is again somewhat too to cyannish. But these two tuples are precisely what could be the result of the Genoa method, and nothing else (the two tuples being the closest discrete values around the true color m along line 130. However, perhaps tuple [7, 12, 9, 14] would give a much more accurate reproduction. This is precisely what the present invention tries to achieve: get a more accurate reproduction, although be it with a reasonable amount of calculations, i.e. starting from a good initial guess such as obtained e.g. from the Genoa method.

Because the driving value generation of the present invention does not test all colors exhaustively (which would be unfeasible, especially for real-time video) there is no guarantee that the very best color reproduction will result. But it can by definition never be worse than the initial reproduction with the Genoa driving values, and will typically be better and not far off from the optimal reproduction.

FIG. 2 schematically shows the calculation unit 220 of the invention in a multi-primary display device. For each image pixel, a standard color specification is inputted e.g. TV being a standard PAL YUV or MPEG YCRCB specification. In any case, this uniquely specifies a color and can be transformed to driving values for reproducing the color. The input is supplied over connection 260 being any of the possible television connections, e.g. a cable connection, or a connection to a disk-reading device. The calculation unit 220 may transform this input color TV to another representation of the target color e.g. T being an X,Y,Z representation, which is because of its linearity practical for doing the subsequent calculations. Therefore, a color space conversion unit 222 may typically be comprised, arranged to apply a (3×3) matrix transformation to the input color and a gamma transformation to the resulting color signals (typically raise them to the power of 2.2), and then a second matrix transformation.

Subsequently a determination unit 224 transforms the target X,Y,Z color (or similar other color representation) into quantized initial values [R′], [G′], [B′] and [C′] (the indicating that the values are in inverse gamma space, i.e. the linear values have been raised e.g. to a power of 1/(2.2) or 0.45, and the square brackets indicating quantization, as is well known in the art). These initial values could already be sent to an electronic multi-primary display unit 200, but then the color reproduction would be suboptimal. The determination unit 224 is so arranged to first apply in a multiprimary transformation unit 226 a conversion of the target color T to linear driving values or weight R,G,B and C. Any smooth conversion algorithm can be applied, e.g. the Genoa method described above with aid of FIG. 1. Subsequently inverse gamma unit 228 applies a non-linear function to take the non-linear behavior of the channels into account. The purpose of this inverse gamma transformation is that when the inverse-gamma-ed value is sent to the display, e.g. as a voltage or digital value, then due to the gamma of the display approximately the correct linear light contribution of the primary channel will be displayed. E.g. it is known that due to the electron gun physics and other factors such as e.g. surround light reflected on the display front, a CRT color channel—e.g. the red channel—can be modeled with a power function with a gamma of e.g. 2.8. Taking into account the psychophysics of viewing in dim surround, for such CRT displays, the inverse gamma function should be power (c, 0.45) [i.e. c^{0.45}], where c is e.g. the linear red driving weight R. An LCD device on the other hand has an S-shaped function. Typically the required behavior is measured and the required inverse gamma functions are stored in look-up tables. Lastly quantizer 230 quantizes the values, e.g. as units between 0 and 255, yielding the quantized initial values [R′], [G′], [B′] and [C′].

The core of the invention is the addition of an optimization unit 232, which is arranged to determine calorimetrically more accurate or “optimal” driving values ([R′]o, [G′]o, [B′]o, [C′]o) based on the initial values. An example of its internal workings is described below with aid of FIG. 3.

FIG. 2 further shows an exemplary 4P display unit 200, namely a DMD-based rear projector. Light from a lamp 204 is filtered by one of four color filters (typically sunbstantially disjunct bandpass-type filters substantially covering the visible spectrum range) in a color wheel 206. The light is subsequently directed by a semi-reflective mirror 208 to a Digital Micromirror device (DMD) 210 functioning as light modulator. When the red filter is in the light path, pixels that require a large red contribution direct light towards the output a large number of elementary times. The correctly modulated/colored light is projected via a projection lens 212 on a display screen 214 at the front of the rear projection display. The optimal driving values [R′]o, [G′]o, [B′]o, [C′]o are input to correctly steer the microscopic mirrors of the DMD in each quarter period.

FIG. 3 schematically shows an exemplary embodiment of an optimization unit 232 of the calculation unit 220.

A candidate generation unit 302 is arranged to determine a set CS of candidate tuples of driving values as the ensemble of tuples composed of those driving values which lie within a number of discrete levels N_{d}, for an associated dimension d (i.e. e.g. within 1, 2 or 3 discrete steps, in the positive or negative direction for each of the driving values) of multi-primary driving value space from the respective initial value ([R′], [G′], [B′], [C′]).

So e.g. if [14, 10, 10, 10] is the initial tuple, [14-1, 10, 10, 10], [14+1, 10, 10, 10], [14, 10-1, 10, 10] etc. are interesting candidates to check their color reproduction. Working this way doesn't guarantee that the optimal reachable color reproduction is found. On the other had it does save considerably on calculations, since e.g. for 6 primaries, exhaustive search would mean checking the reproduction of power (256,6) driving value tuples, which is far too much for real-time video. Checking a small number of alternative candidate tuples for each pixel is however feasible with current hardware and software. As FIG. 4 schematically shows, it is not unlikely that the optimal candidate is close to the initial value (especially for a smooth initial value generation method), and in any case due to the optimization the reproduction can never be worse than with the initial driving values. On average however the accuracy is increased by a number of bits (equivalent), especially near the achromatic axis, and most colors occurring in nature are not very saturated anyway.

An easy implementation of the candidate generation unit 302 functionality is by means of an offsets memory 306 which comprises offset tuples such as [−1, 0, 0, 0], [+1, 0, 0, 0], [0, −1, 0, 0], etc. Such an offset is simply added by a candidate generator 304 arranged to add component-wise a tuple of offsets to the initial values [R′], [G′], [B′], [C′], i.e. e.g. [R′]−1, [G′]+0, . . . .

Instead of checking all possible neighborhood-constrained offset-tuples exhaustively, an offset selector 308 may be present to select according to a predetermined criterion only particular tuples for transmission to the candidate generator 304. E.g. experiments have shown that an a priori selected subsets of the offsets based on statistical criteria as likely leading to improved reproduction works satisfactorily, again reducing the calculation load.

The optimization unit 232 may alternatively be so arranged that the offset selector determines the offset tuple based on the residual error. E.g. if the reproduced color is not red enough, offsets are selected that increase redness, but offsets that decrease redness are disregarded. This is shown schematically in FIG. 5. Here for two color driving components an (two component) error plane is shown in which the direction of the error is decisive in which offset ensembles are retained vs. discarded, this being dependent on which quadrant the error is in (e.g. positive e1 and e2). Also the magnitude of the error is taken into account, since as can be seen the quadrants are divided in four. E.g. in error plane region 502 offset tuples O1 and O2 are likely candidates for improved reproduction accuracy, whereas in quadrant 503, O5 and 06 are, which may have e.g. small component offsets (<2) because only little color correction is required, hence large deviations need not be checked. It is further advantageous to make the offset selection also dependent on where in the gamut the target color is, e.g. close to the gamut border, of (very) high or low luminance, in a particular hue sector, etc., which is realized by giving the offset selector 308 predetermined heuristics.

More advanced methods may adaptively update the selected set of tuples e.g. based on the (gradient) of the error path during successive candidate selection. A candidate driving values tuple DC (i.e. the initial values+a particular currently selected and to be checked offset) is sent to a reproduction evaluation unit 320 which comprises a forward color-mapping unit 322. This unit inverse quantizes and models which reproduced color R the display unit 200 will reproduce, e.g. in X,Y,Z space with an equation which is similar to Eq. 1, namely:

$${( \begin{matrix}X \\ Y \\ Z\end{matrix} )}_{R} = ( \begin{matrix}{X}_{r} & {X}_{g} & {X}_{b} & {X}_{c} \\ {Y}_{r} & {Y}_{g} & {Y}_{b} & {Y}_{c} \\ {Z}_{r} & {Z}_{g} & {Z}_{b} & {Z}_{c}\end{matrix} ) ( \begin{matrix}{Γ}_{r} ( {R}^{′} ) \\ {Γ}_{g} ( {G}^{′} ) \\ {Γ}_{b} ( {B}^{′} ) \\ {Γ}_{c} ( {C}^{′} )\end{matrix} ) + B \qquad [ Eq . 2 ]$$

in which there is now also a cyan driving component, and similarly in a six primary display e.g. an additional yellow YE and magenta MG primary, etc.

This equation is very simple and follows from the linear additivity of the display. Other color spaces are possible, e.g. CIE-Lab space, in which case the forward color mapping unit 322 typically comprises an extra conversion from X,Y,Z space to Lab space. An error evaluation unit 324 evaluates (checks) the accuracy of the reproduction, i.e. the distance of the reproduced color R to the target color T according to some distance formula in some color space. E.g. the perceptually popular DELab or increased accuracy improvements thereof may be employed. Or a simple error formula is e.g. e=|X_{R}−X_{T}|+|Y_{R}−Y_{T}|+|Z_{R}−Z_{T}|.

It is advantageous if the error formula contains different weighing factors for errors in luminance and in chrominance (e.g. in a and b differences in Lab). To the offset selector as described above, the different error components are sent in a tuple and on the other output a scalar error is output to an error value analyzer 326. If the error e is smaller than the current smallest error e0, then the current driving values are stored in a memory 330. A stop condition detector may also be present, e.g. if the third checked offset already produces an accuracy which is below what may statistically be expected as the end accuracy, the rest of the offsets need not be examined. Candidates may also be saved in an intermediate memory 310, and fetched at will.

The present calculation hardware may be combined with error diffusion or statistical noise concealing algorithms. In such an embodiment an error diffusion block 350 is present, which calculates a part of the error which is allowed for the current pixel (e.g. according to the Floyd-Steinberg algorithm) and the rest of the error is taken into account in neighboring pixels. This influences the candidate generation.

The present calculation unit and method is useful for all kinds of multiprimary displays, but especially useful for low bit depth displays. Currently a number of mobile displays have a low bit depth, e.g. five bits per channel. As an alternative to the classical dithering the currently described multiprimary method can increase the color accuracy, often without sacrificing resolution.

The algorithmic components disclosed in this text may in practice be (entirely or in part) realized as hardware (e.g. parts of an application specific IC) or as software running on a special digital signal processor, or a generic processor, etc.

Under computer program product should be understood any physical realization of a collection of commands enabling a processor—generic or special purpose—, after a series of loading steps (which may include intermediate conversion steps, like translation to an intermediate language, and a final processor language) to get the commands into the processor, to execute any of the characteristic functions of an invention. In particular, the computer program product may be realized as data on a carrier such as e.g. a disk or tape, data present in a memory, data traveling over a network connection—wired or wireless—, or program code on paper. Apart from program code, characteristic data required for the program may also be embodied as a computer program product.

Some of the steps required for the working of the method may be already present in the functionality of the processor instead of described in the computer program product, such as data input and output steps.

It should be noted that the above-mentioned embodiments illustrate rather than limit the invention. Apart from combinations of elements of the invention as combined in the claims, other combinations of the elements are possible. Any combination of elements can be realized in a single dedicated element.

Any reference sign between parentheses in the claim is not intended for limiting the claim. The word “comprising” does not exclude the presence of elements or aspects not listed in a claim. The word “a” or “an” preceding an element does not exclude the presence of a plurality of such elements.

1. A calculation unit (220) arranged for calculating based on an input target color (T,TV) as output a number (n), larger than three, of quantized driving values ([R′]o, [G′]o, [B′]o, [C′]o) usable for driving an electronic multi-primary display unit (200) with the same number (n) of primaries to substantially reproduce the target color (T,TV),
in which calculation unit a determination unit (224) is comprised, arranged to determine, based upon the target color (T,TV), quantized initial values ([R′], [G′], [B′], [C′]) for each of the quantized driving values, and
in which calculation unit an optimization unit (232) is comprised arranged to:
generate a set (CS) of candidate tuples of quantized driving values based on the quantized initial values ([R′], [G′], [B′], [C′]); and
select the quantized driving values ([R′]o, [G′]o, [B′]o, [C′]o) from the set (CS) as a candidate which leads to reproduction (RP) of a color which is closest over all candidates in the set (CS) to the target color (T,TV) according to a predetermined error criterion (E(R,T)).

2. A calculation unit (220) as claimed in claim 1, in which the optimization unit (232) comprises a candidate generation unit (302) arranged to determine the set (CS) of candidate tuples of driving values as the ensemble of tuples of those driving values which lie within a number of discrete levels N_{d}, for an associated dimension d, of multi-primary driving value space from the respective initial value ([R′], [G′], [B′], [C′]).

3. A calculation unit (220) as claimed in claim 2, in which the candidate generation unit (302) comprises an offsets memory (306), containing driving value offset tuples, which are predetermined based on experiments as having a high probability of generating a closer to target candidate when added to the initial values ([R′], [G′], [B′], [C′]), and a candidate generator (304) arranged to add component-wise a tuple of offsets to the initial values ([R′], [G′], [B′], [C′]).

4. A calculation unit (220) as claimed in claim 2, in which the candidate generation unit (302) comprises an offsets memory (306), containing driving value offset tuples, and an offset selector (308) arranged to select according to a predetermined criterion a particular tuple of offsets (O1, FIG. 5) in dependence on an error (e) being the evaluation result of the predetermined error criterion (E(R,T)), and a candidate generator (304) arranged to add component-wise the particular tuple of offsets (O1) to the initial values ([R′], [G′], [B′], [C′]).

5. A calculation unit (220) as claimed in claim 4, in which the offset selector (308) is further arranged to select the particular tuple of offsets (O1, FIG. 5) in dependence on the target color (T).

6. A calculation unit (220) as claimed in claim 1, in which the optimization unit (232) comprises an error evaluation unit (324) arranged to evaluate the predetermined error criterion (E(R,T)) having a different contribution to the resulting error (e) of luminance versus chromaticity errors.

7. A multi-primary display device (250) comprising:
i. a calculation unit (220) as claimed in claim 1, and
ii. multi-primary display unit (200) connected to the calculation unit (220) to receive the quantized driving values ([R′]o, [G′]o, [B′]o, [C′]o).

8. A method of calculating based on an input target color (T,TV) as output a number (n), larger than three, of quantized driving values ([R′]o, [G′]o, [B′]o, [C′]o) usable for driving an electronic multi-primary display unit (200) with the same number (n) of primaries to substantially reproduce the target color (T,TV), comprising:
i. determining based upon the target color (T,TV) quantized initial values ([R′], [G′], [B′], [C′]) for each of the driving values;
ii. generating a set (CS) of candidate tuples of quantized driving values based on the quantized initial values ([R′], [G′], [B′], [C′])
iii. determining the quantized driving values ([R′]o, [G′]o, [B′]o, [C′]o) by selecting from the set (CS) a candidate which leads to reproduction (RP) of a color which is closest over all candidates in the set (CS) to the target color (T,TV) according to a predetermined error criterion (E(R,T)).

9. A computer program product comprising a processor readable means to enable a processor to execute the method according to claim 8, the processor readable means comprising:
i. Means for determining based upon a target color (T,TV) quantized initial values ([R′], [G′], [B′], [C′]);
ii. Means for generating a set (CS) of candidate tuples of quantized driving values based on the quantized initial values ([R′], [G′], [B′], [C′]); and
iii. Means for determining output quantized driving values ([R′]o, [G′]o, [B′]o, [C′]o) by selecting from the set (CS) a candidate which leads to reproduction (RP) of a color which is closest over all candidates in the set (CS) to the target color (T,TV) according to a predetermined error criterion (E(R,T)).
